(19) United States
(12) Patent Application Publication
(10) Pub. No.: US 2018/0003525 A1
(43) Pub. Date: Jan. 4, 2018

(54) Linear Measurement Device

(71) Applicant: Novatek IP, LLC, Provo, UT (US)

(72) Inventors: David R. Hall, Provo, UT (US); Jim Shumway, Saratoga Springs, UT (US); Jonathan D. Marshall, Mapleton, UT (US); Jeffrey Parrott, Draper, UT (US); Casey Webb, Spanish Fork, UT (US); Scott R. Woolston, Spanish Fork, UT (US)

(21) Appl. No.: 15/200,334

(22) Filed: Jul. 1, 2016

(51) Int. Cl. G01D 5/245

(52) U.S. Cl. CPC G01D 5/2451

(57) ABSTRACT

A linear measurement device may be formed from a first tube axially translatable with respect to a second tube. Inside the first tube may be placed a sensor capable of sensing a magnetic field. A magnet may also be found within the first tube and produce a magnetic field sensible by the sensor. The second tube may comprise a plurality of deviations disposed therealong capable of altering the magnetic field when near the magnet. As the first tube is axially translated with respect to the second tube, the sensor may sense alterations in the magnetic field due to the plurality of deviations thus allowing for a linear displacement to be determined.

### BACKGROUND

Many endeavors call for measuring a position of one object relative to another. Measuring the linear movement of one object relative to another may also be desirable in a great variety of situations. One mechanism capable of measuring such positioning or linear movement is known as a linear variable differential transformer (LVDT). LVDTs generally operate by driving an electrical current through a primary solenoid coil that may cause an induction current to be generated in secondary solenoid coils disposed axially on either side of the primary coil. A cylindrical ferromagnetic core, attached to the object whose position is to be measured, may slide along an axis between the primary and secondary coils and alter the induced current as it moves. When the core is displaced toward one of the secondary coils, the voltage in that secondary coil may increase as the voltage in the other secondary coil decreases and vice versa. While this design may have a variety of advantages, the length that may be measured may be limited given that it is the proximity to edges of the core the causes the induced currents to rise and fall.

Another mechanism for measuring linear displacement, having a longer possible stroke than previously described LVDTs, may comprise a tube with ferromagnetic ball bearings disposed therein. This series of ball bearings may act as a scale around which a plurality of coils may pass. As in a traditional LVDT, an electrical current may be driven through one of the coils while a number of other spaced pickup coils detect variations in induced magnetic fields. However, in this case, the ball bearings may create a repeating differentiation in the induced magnetic fields. While this design may allow for longer measurement stroke, it still requires coils of wire spaced around a center, just like traditional LVDTs, which may add to its size, complexity, cost and structural weakness.

Thus, while conventional LVDTs and other known linear position sensors have many advantages, a linear measurement device comprising fewer parts, more robust construction, smaller size, simplified circuitry, or reduced cost may be desirable. Further, while conventional LVDTs may require alternating current that may draw significant power, a linear measurement device with reduced power demands may be desirable. Additionally, the relatively short measurement stroke of conventional LVDTs often requires a scaling of the measured signals. A linear measurement device comprising a longer stroke may not require such scaling and, thus, may be desirable.

### BRIEF DESCRIPTION

A relatively small linear measurement device may comprise few working parts, a robust construction and simple electrical circuitry. Such a linear measurement device may be formed from a first tube axially translatable with respect to a second tube. Inside the first tube may be placed a sensor capable of sensing a magnetic field. A magnet may also be found within the first tube and produce a magnetic field sensible by the sensor. The second tube may comprise a plurality of deviations disposed therealong capable of altering the magnetic field when near the magnet. As the first tube is axially translated with respect to the second tube, the sensor may sense alterations in the magnetic field due to the plurality of deviations thus allowing for a linear displacement to be determined.

### DRAWINGS

FIGS. 1-1 and 1-2 are an orthogonal view and a longitude-sectional view respectively of an embodiment of a linear measurement device comprising two tubes with FIG. 1-2 showing a magnified view of a magnet and sensor pairing within one of the tubes. FIG. 1-3 is a perspective view of the magnet and sensor pairing shown in FIG. 1-2.

FIG. 2 is a perspective view of a sectioned embodiment of a tube comprising a plurality of holes disposed in a sidewall thereof that could be used in conjunction with a linear measurement device.

FIG. 3 is a perspective view of another sectioned embodiment of a tube comprising radial fluctuations disposed thereon that could be used in conjunction with a linear measurement device.

FIG. 4 is a perspective view of another sectioned embodiment of a tube comprising alternating materials that could be used in conjunction with a linear measurement device. FIGS. 4-1, 4-2 and 4-3 are orthogonal and longitude-sectional views of various embodiments of annular forms comprising different internal shapes that could be stacked to form a tube.

### DETAILED DESCRIPTION

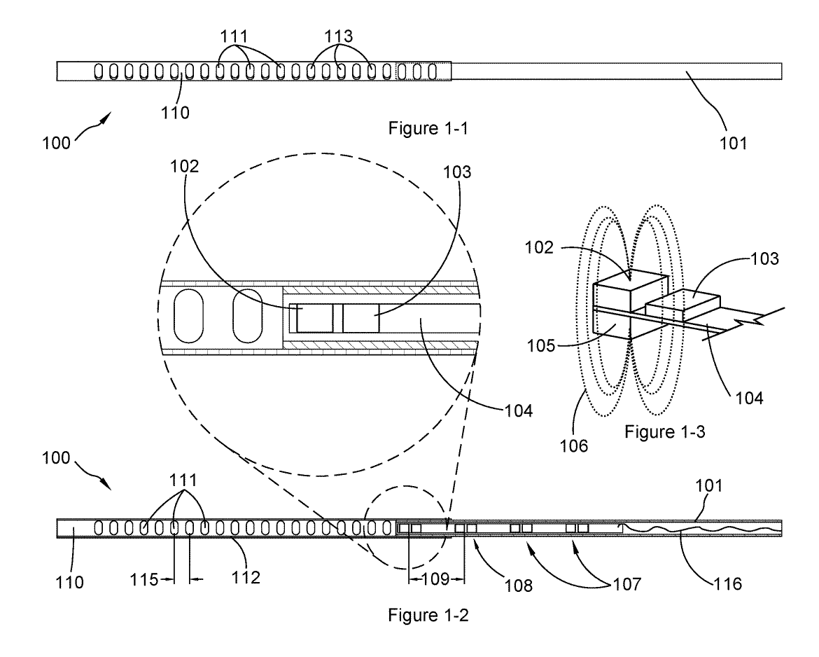

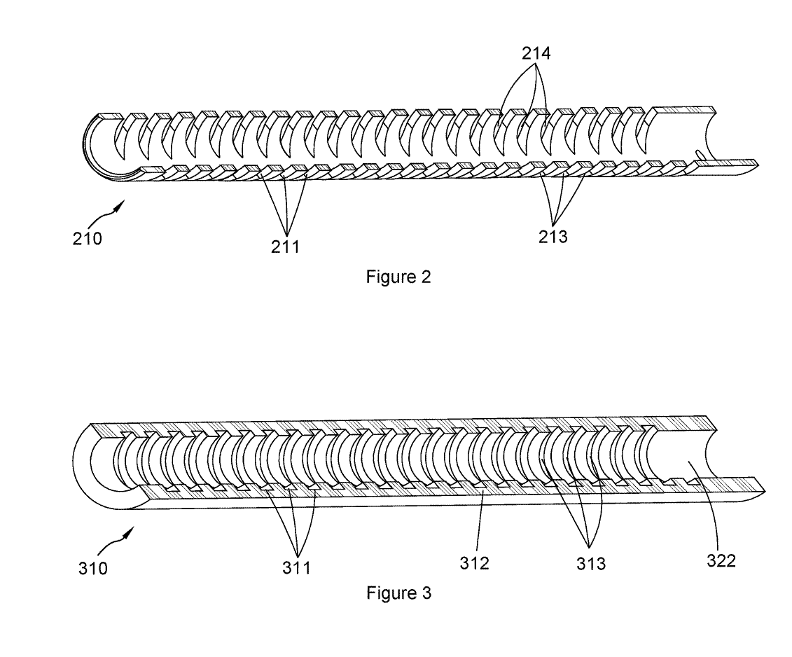

FIGS. 1-1 and 1-2 show an embodiment of linear measurement device 100 comprising two tubes. A first tube 101 may be disposed within a second tube 110 such that they may translate axially with respect to one another. The first tube 101 may comprise at least one magnet 102 and sensor 103 pairing. The magnet 102 may comprise any of a variety of permanent magnets or electromagnets. As shown in a magnified view of FIG. 1-2 and FIG. 1-3, the magnet 102 may be attached to a circuit board 104 disposed within the first tube 101 axially adjacent the sensor 103. The circuit board 104 may provide a practical, convenient and efficient platform that may be inserted into the first tube 101 after manufacture. However, other embodiments of similar linear measurement devices may be constructed differently while achieving similar results. As also shown in the present embodiment, the circuit board 104 may be disposed on a central axis of the first tube 101 with a second magnet 105 disposed radially opposite the magnet 102 on an opposing face of the circuit board 104. It has been found that positioning two magnets opposite one another on either side of a circuit board may help to balance magnetic fields emanating therefrom. However, two magnets are not necessary and one may suffice.

The magnet 102 may produce a magnetic field 106 capable of being sensed by the sensor 103. Further, the second tube 110 may comprise a plurality of deviations 111 disposed thereon capable of altering the magnetic field 106 when in proximity thereto. Not only may the sensor 103 sense the magnetic field 106, but it may also be capable of sensing alterations in the magnetic field 106 due to the deviations 111. Additionally, while the present embodiment shows the sensor 103 positioned axially adjacent the magnet 102, such sensors could also be placed in various positions, such as off axis, relative to magnets based on where they are likely to experience substantial changes in magnetic field due to interactions with a second tube. Further, if deviations disposed on a second tube are not symmetric about an axis thereof then it may be advantageous to specifically orient such sensors in relation to the deviations.

The second tube 110 may be formed of a material comprising a relative permeability significantly greater than unity. As such, physical variations in a sidewall 112 of the second tube 110 may form the plurality of deviations 111. For example, in the embodiment shown, the plurality of deviations 111 may comprise a plurality of holes 113 disposed in the sidewall 112 of the second tube 110. As shown, the plurality of holes 113 may each be substantially identical in shape and evenly spaced axially along the second tube 110. This plurality of holes 113 may be formed by any of a variety of machining or cutting methods. While such a configuration may be desirable in many situations due to its axial consistency, other embodiments comprising uneven configurations could provide a variation in resolution along the displacement.

In the magnified view of FIG. 1-2, a first pairing of magnet 102 and sensor 103 is shown disposed proximate one end of the first tube 101. This single pairing may be sufficient in many applications. Other axial positions of the first pairing may also function just as well as that shown. In the present embodiment however, this positioning makes room for additional magnet and sensor pairings 107 disposed along the circuit board 104 of the first tube 101. It is believed that these additional magnet and sensor pairings 107 may increase signal-to-noise ratio and minimize the noise amplification inherent at zero-amplitude crossings. As an example of one such additional magnet and sensor pairing, a second magnet and sensor pairing 108 may be disposed at some axial distance 109 along the first tube 101 from the first pairing. The axial distance 109 between the first pairing and the second pairing 108 may be substantially different from a distance 115 between each of the plurality of deviations 111. It is believed that a desirable distance 109 between the first pairing and the second pairing 108 may be generally N/4 times the distance 115 between each of the plurality of deviations 111 where N is an odd number. This is because even values of N may actually create a redundancy in the design and result in a measurement equivalent to just one sensor. In the present embodiment, while not shown exactly to scale, N is represented as 15 for reference.

The circuit board 104 may comprise electronics capable of interpreting data from the sensors and calculating linear displacement of the first tube 101 relative to the second tube 110. The electronics may further comprise a counter capable of counting repetitive magnetic field alterations sensed by the sensors. A wire 116 extending from the circuit board 104 along the first tube 101 may electrically connect the sensors to further electronics outside the first tube 101.

In addition, while the present embodiment shows magnets and sensors disposed within an inner tube and magnetic field altering deviations disposed on an outer tube, a reverse configuration comprising magnets and sensors on an outer tube and deviations on an inner tube may function similarly.

FIG. 2 shows an embodiment of a tube 210 similar to the second tube 110 discussed in reference to FIGS. 1-1 and 1-2. FIG. 2 shows clearly how a plurality of deviations 211 may comprise a second series of holes 214 disposed radially opposite a first plurality of holes 213 on the tube 210.

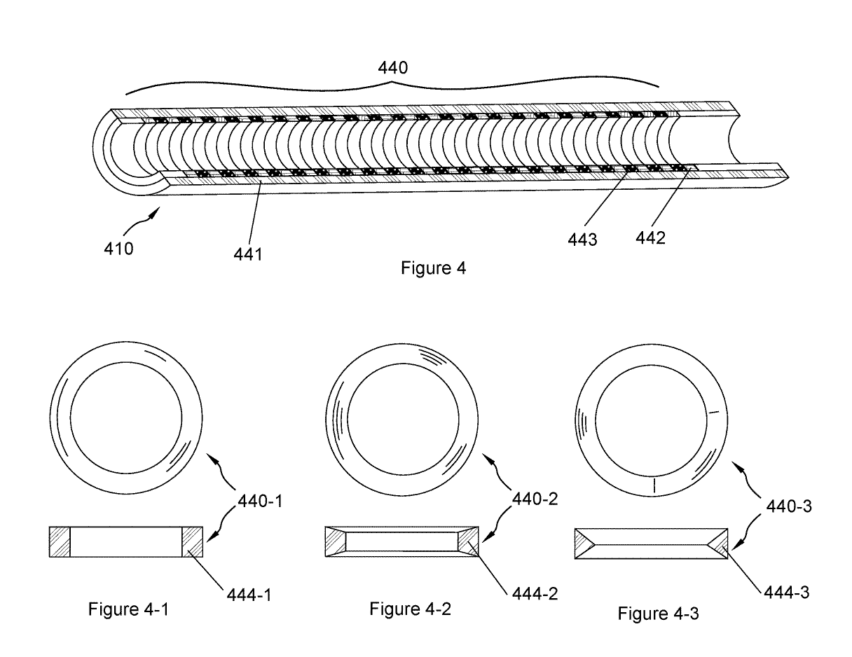

FIG. 3 shows another embodiment of a tube 310 that could be employed in a similar manner to the tube 210 discussed in reference to FIG. 2. In this embodiment, a plurality of deviations 311 comprises a plurality of radial fluctuations 313 shaped like annular grooves cut into an interior surface 322 of a sidewall 312 of the tube 310. It is believed that annular grooves cut into the interior surface 322 of the tube 310 may be capable of altering a magnetic field when in proximity thereto while providing more rigidity to the tube 310 than the plurality of holes 213 shown in FIG. 2. In addition, by forming the annular grooves completely around the interior surface 322, sensors forming part of a related linear measurement device may not need to be specifically oriented in relation to the plurality of deviations 311.

FIG. 4 shows yet another embodiment of a tube 410 that could be employed in a similar manner to the tubes 210, 310 discussed previously. Tube 410 may comprise a stack of annular forms 440 held together by an outer sleeve 441. The annular forms 440 may alternate between those constructed of materials comprising a relative permeability significantly greater than unity 442 and those constructed of materials comprising a relative permeability approximately unity 443. It is believed that the alternating materials may be capable of altering a magnetic field when in proximity to a magnet. Additionally, as the annular forms 440 completely surround the tube 410, sensors forming part of a related linear measurement device may not need to be specifically oriented.

FIGS. 4-1, 4-2 and 4-3 show various possible embodiments of annular forms 440-1, 440-2 and 440-3 that could be used to construct a tube similar to that shown in FIG. 4. Inner shapes of the annular forms 440-1, 440-2 and 440-3 may differ to alter a magnetic field in different ways. For instance, annular form 440-1 comprises a generally rectangular cross section 444-1, annular form 440-2 comprises a generally trapezoidal cross section 444-2, and annular form 440-3 comprises a generally triangular cross section 444-3.

Whereas the present invention has been described in particular relation to the drawings attached hereto, it should be understood that other and further modifications apart from those shown or suggested herein, may be made within the scope and spirit of the present invention.

1. A linear measurement device, comprising:
a first tube axially translatable with respect to a second tube;
the first tube comprising a magnet, producing a magnetic field, and a sensor, capable of sensing alterations in the magnetic field; and
the second tube comprising a plurality of deviations disposed therealong capable of altering the magnetic field.

2. The device of claim 1, wherein the first tube is disposed within the second tube.

3. The device of claim 1, wherein the second tube is formed of a material comprising a relative permeability significantly greater than unity.

4. The device of claim 1, wherein the deviations comprise a plurality of holes disposed in a sidewall of the second tube.

5. The device of claim 4, wherein the plurality of holes are evenly spaced axially along the second tube.

6. The device of claim 5, wherein each of the plurality of holes are substantially identical in shape.

7. The device of claim 4, wherein the plurality of holes comprises two opposing series of holes disposed axially along the second tube.

8. The device of claim 1, wherein the deviations comprise a plurality of radial fluctuations disposed in a sidewall of the second tube.

9. The device of claim 8, wherein the plurality of radial fluctuations are formed on an interior surface of the second tube.

10. The device of claim 8, wherein the plurality of radial fluctuations comprises a series of annular grooves disposed on a surface of the second tube.

11. The device of claim 1, wherein the deviations comprise alternating material comprising a relative permeability significantly greater than unity and material comprising a relative permeability approximately unity forming a sidewall of the second tube.

12. The device of claim 11, wherein the sidewall of the second tube is formed from a stack of annular forms alternatingly comprising a relative permeability significantly greater than unity and comprising a relative permeability approximately unity.

13. The device of claim 1, wherein the magnet and the sensor form a first pairing disposed at some axial distance along the first tube from a second magnet and sensor pairing.

14. The device of claim 13, wherein the distance between the first pairing and the second pairing is substantially different from a distance between each of the plurality of deviations.

15. The device of claim 14, wherein the distance between the first pairing and the second pairing is generally N/4 times the distance between each of the plurality of deviations where N is an odd number.

16. The device of claim 13, further comprising one or more additional magnet and sensor pairings disposed along the first tube.

17. The device of claim 1, wherein the magnet and sensor are disposed proximate one end of the first tube.

18. The device of claim 1, wherein the magnet is disposed radially on one side of an axis of the first tube opposite a second magnet radially on an opposite side thereof.

19. The device of claim 1, further comprising at least one electrical wire connected to the sensor and extending through the first tube.

20. The device of claim 1, further comprising a counter in communication with the sensor capable of counting repetitive magnetic field alterations sensed by the sensor.
